(19) United States
(12) Patent Application Publication
(10) Pub. No.: US 2017/0011778 A1
(43) Pub. Date: Jan. 12, 2017

(54) Solvent-Based Mitigating Of Organic Contaminants In A Hard Disk Drive

(71) Applicant: HGST Netherlands B.V., Amsterdam (NL)

(72) Inventors: Bala Krishna Pathem, Fremont, CA (US); Vedantham Raman, Morgan Hill, CA (US)

(21) Appl. No.: 14/794,730

(22) Filed: Jul. 8, 2015

(51) Int. Cl. G11B 33/14; C11D 11/00; B08B 1/00; C11D 7/24

(52) U.S. Cl. CPC G11B 33/1453; C11D 7/245; C11D 7/247; C11D 11/0047; B08B 1/006

(57) ABSTRACT

Mitigating organic contaminants within a hard disk drive (HDD) may include introducing an organic solvent into the HDD to dissolve organic contaminants and, therefore, to inhibit such contaminants from fouling operation of the HDD device. Organic solvents such as toluene and/or hexane may be used to dissolve organic contaminants such as hydrocarbons and siloxanes.

### FIELD OF EMBODIMENTS

Embodiments of the invention may relate generally to hard disk drives and more particularly to an approach to mitigating organic contaminants.

### BACKGROUND

A hard-disk drive (HDD) is a non-volatile storage device that is housed in a protective enclosure and stores digitally encoded data on at least one circular disk having magnetic surfaces. When an HDD is in operation, each magnetic-recording disk is rapidly rotated by a spindle system. Data is read from and written to a magnetic-recording disk using a read-write head that is positioned over a specific location of a disk by an actuator. A read-write head uses a magnetic field to read data from and write data to the surface of a magnetic-recording disk. A write head makes use of the electricity flowing through a coil, which produces a magnetic field. Electrical pulses are sent to the write head, with different patterns of positive and negative currents. The current in the coil of the write head induces a magnetic field across the gap between the head and the magnetic disk, which in turn magnetizes a small area on the recording medium.

Increasing areal density, a measure of the quantity of information bits that can be stored on a given area of disk surface, is one of the ever-present goals of HDD design evolution. As areal density increases, the read/write head generally needs to fly closer and closer to the disk surface. This demand for reducing the head-media spacing (“HMS”) could involve reducing the thickness of the disk media overcoat and/or lubricant layers. However, the foregoing approach is likely to come with the expense of compromising the robustness of the lubricant toward contamination. For example, organic contaminants within an HDD can play a significant role in reducing the reliability of an HDD because such contaminants on the surface of the head slider and/or on the surface of the disk can cause head-disk contact, or “crashes”. Additionally, contaminants can attach to the head slider and cause undesirable flying height changes. Thus, removal or mitigation of contaminants within an HDD poses an HDD design and development challenge.

Any approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### SUMMARY OF EMBODIMENTS

Embodiments of the invention are generally directed toward an approach to mitigating organic contaminants within a hard disk drive (HDD), which may include introducing an organic solvent into the HDD to dissolve organic contaminants and, therefore, to inhibit such contaminants from fouling operation of the HDD device. Embodiments may include the use of organic solvents such as toluene and/or hexane to dissolve organic contaminants such as hydrocarbons and siloxanes.

Embodiments discussed in the Summary of Embodiments section are not meant to suggest, describe, or teach all the embodiments discussed herein. Thus, embodiments of the invention may contain additional or different features than those discussed in this section. Furthermore, no limitation, element, property, feature, advantage, attribute, or the like expressed in this section, which is not expressly recited in a claim, limits the scope of any claim in any way.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a plan view illustrating a hard disk drive (HDD), according to an embodiment; and

FIG. 2 is a flow diagram illustrating a method for mitigating organic contaminants within a hard disk drive, according to an embodiment.

### DETAILED DESCRIPTION

Approaches to mitigating organic contaminants within a hard disk drive are described. In the following description, for the purposes of explanation, numerous specific details are set forth in order to provide a thorough understanding of the embodiments of the invention described herein. It will be apparent, however, that the embodiments of the invention described herein may be practiced without these specific details. In other instances, well-known structures and devices are shown in block diagram form in order to avoid unnecessarily obscuring the embodiments of the invention described herein.

### Physical Description of Illustrative Operating Context

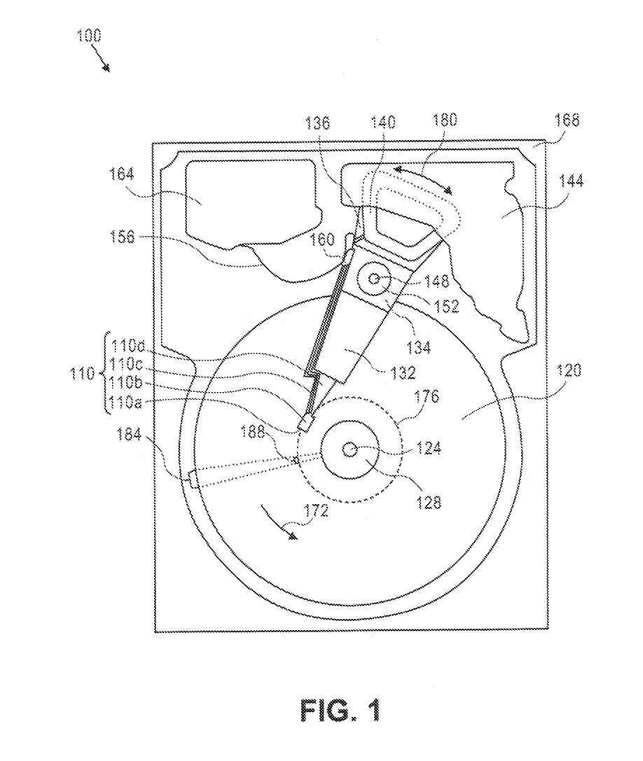

Embodiments may be used in the context of mitigating organic contaminants within a hard disk drive (HDD) storage device. Thus, in accordance with an embodiment, a plan view illustrating an HDD 100 is shown in FIG. 1 to illustrate an exemplary operating context.

FIG. 1 illustrates the functional arrangement of components of the HDD 100 including a slider 110b that includes a magnetic read-write head 110a. Collectively, slider 110b and head 110a may be referred to as a head slider. The HDD 100 includes at least one head gimbal assembly (HGA) 110 including the head slider, a lead suspension 110c attached to the head slider typically via a flexure, and a load beam 110d attached to the lead suspension 110c. The HDD 100 also includes at least one magnetic-recording medium 120 rotatably mounted on a spindle 124 and a drive motor (not visible) attached to the spindle 124 for rotating the medium 120. The read-write head 110a, which may also be referred to as a transducer, includes a write element and a read element for respectively writing and reading information stored on the medium 120 of the HDD 100. The medium 120 or a plurality of disk media may be affixed to the spindle 124 with a disk clamp 128.

The HDD 100 further includes an arm 132 attached to the HGA 110, a carriage 134, a voice-coil motor (VCM) that includes an armature 136 including a voice coil 140 attached to the carriage 134 and a stator 144 including a voice-coil magnet (not visible). The armature 136 of the VCM is attached to the carriage 134 and is configured to move the arm 132 and the HGA 110, to access portions of the medium 120, being mounted on a pivot-shaft 148 with an interposed pivot bearing assembly 152. In the case of an HDD having multiple disks, the carriage 134 is called an “E-block,” or comb, because the carriage is arranged to carry a ganged array of arms that gives it the appearance of a comb.

An assembly comprising a head gimbal assembly (e.g., HGA 110) including a flexure to which the head slider is coupled, an actuator arm (e.g., arm 132) and/or load beam to which the flexure is coupled, and an actuator (e.g., the VCM) to which the actuator arm is coupled, may be collectively referred to as a head stack assembly (HSA). An HSA may, however, include more or fewer components than those described. For example, an HSA may refer to an assembly that further includes electrical interconnection components. Generally, an HSA is the assembly configured to move the head slider to access portions of the medium 120 for read and write operations.

With further reference to FIG. 1, electrical signals (e.g., current to the voice coil 140 of the VCM) comprising a write signal to and a read signal from the head 110a, are provided by a flexible interconnect cable 156 (“flex cable”). Interconnection between the flex cable 156 and the head 110a may be provided by an arm-electronics (AE) module 160, which may have an on-board pre-amplifier for the read signal, as well as other read-channel and write-channel electronic components. The AE module 160 may be attached to the carriage 134 as shown. The flex cable 156 is coupled to an electrical-connector block 164, which provides electrical communication through electrical feedthroughs provided by an HDD housing 168. The HDD housing 168, also referred to as a base, in conjunction with an HDD cover provides a sealed, protective enclosure for the information storage components of the HDD 100.

Other electronic components, including a disk controller and servo electronics including a digital-signal processor (DSP), provide electrical signals to the drive motor, the voice coil 140 of the VCM and the head 110a of the HGA 110. The electrical signal provided to the drive motor enables the drive motor to spin providing a torque to the spindle 124 which is in turn transmitted to the medium 120 that is affixed to the spindle 124. As a result, the medium 120 spins in a direction 172. The spinning medium 120 creates a cushion of air that acts as an air-bearing on which the air-bearing surface (ABS) of the slider 110b rides so that the slider 110b flies above the surface of the medium 120 without making contact with a thin magnetic-recording layer in which information is recorded. Similarly in an HDD in which a lighter-than-air gas is utilized, such as helium for a non-limiting example, the spinning medium 120 creates a cushion of gas that acts as a gas or fluid bearing on which the slider 110b rides.

The electrical signal provided to the voice coil 140 of the VCM enables the head 110a of the HGA 110 to access a track 176 on which information is recorded. Thus, the armature 136 of the VCM swings through an arc 180, which enables the head 110a of the HGA 110 to access various tracks on the medium 120. Information is stored on the medium 120 in a plurality of radially nested tracks arranged in sectors on the medium 120, such as sector 184. Correspondingly, each track is composed of a plurality of sectored track portions (or “track sector”), for example, sectored track portion 188. Each sectored track portion 188 may be composed of recorded data and a header containing a servo-burst-signal pattern, for example, an ABCD-servo-burst-signal pattern, which is information that identifies the track 176, and error correction code information. In accessing the track 176, the read element of the head 110a of the HGA 110 reads the servo-burst-signal pattern which provides a position-error-signal (PES) to the servo electronics, which controls the electrical signal provided to the voice coil 140 of the VCM, enabling the head 110a to follow the track 176. Upon finding the track 176 and identifying a particular sectored track portion 188, the head 110a either reads data from the track 176 or writes data to the track 176 depending on instructions received by the disk controller from an external agent, for example, a microprocessor of a computer system.

An HDD's electronic architecture comprises numerous electronic components for performing their respective functions for operation of an HDD, such as a hard disk controller (“HDC”), an interface controller, an arm electronics module, a data channel, a motor driver, a servo processor, buffer memory, etc. Two or more of such components may be combined on a single integrated circuit board referred to as a “system on a chip” (“SOC”). Several, if not all, of such electronic components are typically arranged on a printed circuit board that is coupled to the bottom side of an HDD, such as to HDD housing 168.

References herein to a hard disk drive, such as HDD 100 illustrated and described in reference to FIG. 1, may encompass a data storage device that is at times referred to as a “hybrid drive”. A hybrid drive refers generally to a storage device having functionality of both a traditional HDD (see, e.g., HDD 100) combined with solid-state storage device (SSD) using non-volatile memory, such as flash or other solid-state (e.g., integrated circuits) memory, which is electrically erasable and programmable. As operation, management and control of the different types of storage media typically differs, the solid-state portion of a hybrid drive may include its own corresponding controller functionality, which may be integrated into a single controller along with the HDD functionality. A hybrid drive may be architected and configured to operate and to utilize the solid-state portion in a number of ways, such as, for non-limiting examples, by using the solid-state memory as cache memory, for storing frequently-accessed data, for storing I/O intensive data, and the like. Further, a hybrid drive may be architected and configured essentially as two storage devices in a single enclosure, i.e., a traditional HDD and an SSD, with either one or multiple interfaces for host connection.

### Introduction

As discussed, organic and other contaminants within an HDD can play a significant role in reducing the reliability of an HDD because such contaminants on the surface of the head slider and/or on the surface of the disk can cause head-disk “crashes” and/or can lead to undesirable flying height changes.

Possible approaches to handling HDD contamination issues include (a) employing vapor phase lubricant into the HDD, which can deposit onto the head slider and increase the flying height; (b) increasing the thickness of the disk lubricant, which could negatively affect the head-media spacing directly; and (c) implementing design changes to the pivot bearing assembly, a major contributor to the hydrocarbon contaminant problem, which have a corresponding cost. Thus, each of the foregoing may provide some temporary relief to the contamination problem, but each with corresponding undesirable effects.

### Method for Mitigating Organic Contaminants

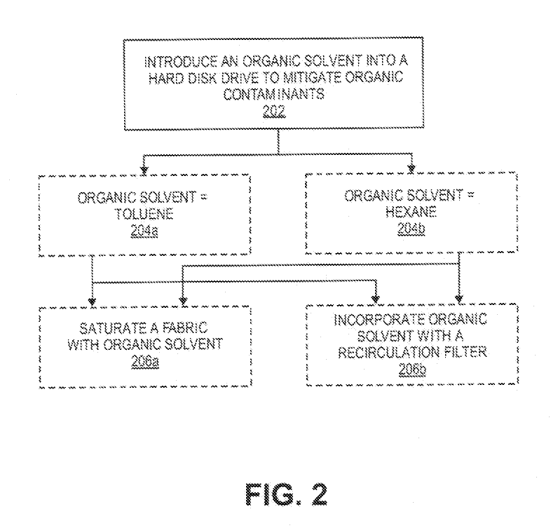

FIG. 2 is a flow diagram illustrating a method for mitigating organic contaminants with a hard disk drive.

At block 202, an organic solvent is introduced into a hard disk drive (HDD) to mitigate organic contaminants therein, where mitigation refers to making something less severe, harmful, hostile, and the like. Generally, a solvent is a substance that can dissolve a chemically different material. As such, the organic solvent alters the chemical composition within the HDD. A solvent having a sufficient vapor pressure to diffuse inside the HDD and to mitigate (e.g., by dissolving and/or otherwise) the target contaminants is a consideration. The selection of a particular organic solvent for introduction into an HDD may vary from implementation to implementation, as there are many organic solvents to choose from. Generally, an organic solvent molecule comprises at least one carbon (C) atom and at least one hydrogen (H) atom.

Solvents can be broadly classified as polar or non-polar, where a polar solvent may be used to dissolve a polar contaminant and a non-polar solvent may be used to dissolve a non-polar contaminant. Thus, whether a polar organic solvent or a non-polar organic solvent is introduced into the HDD may vary from implementation to implementation depending, for example, on the type of contaminant being targeted for mitigation.

It is found that at a certain fraction of the monolayer lubricant on a recording disk medium, i.e., at a certain percentage of the crowding ratio of the disk lubricant, organic contaminant adsorption to the disk medium becomes more and more prevalent, generally because less crowding results in more sites at which contaminants may adsorb. Furthermore, the manner in which organic contaminants adsorb to the disk medium is believed to be physisorption, whereby the electronic structure of the contaminant is largely unchanged upon adsorption, rather than by a chemical bond. Still further, generally hydrocarbons and siloxanes are one of the major contributors to organic contaminants within an HDD, possibly comprising up to 60%-70% of the HDD contaminants. Thus, hydrocarbons and siloxanes are a target for mitigation/dissolution in the context of a hard disk drive.

According to one embodiment, toluene (C₇H₈) is introduced into the HDD (optional block 204a of FIG. 2) in order to dissolve organic contaminants within the HDD, such as hydrocarbons and siloxanes. According to another embodiment, hexane (C₆H₁₄) is introduced into the HDD (optional block 204b of FIG. 2) in order to dissolve organic contaminants within the HDD, such as hydrocarbons and siloxanes. Both toluene and hexane have shown efficacy for reducing the levels of the types of hydrocarbons and siloxanes that commonly deposit onto a head slider in an HDD. However, as discussed, other organic solvents may be introduced into the HDD and still fall within the scope of embodiments described herein.

Another factor to consider with respect to the efficacy of introducing an organic solvent into an HDD to mitigate, dissolve, trap organic contaminants, is the vapor pressure of the solvent used. Vapor pressure can serve as an indication of a liquid's evaporation rate. Thus, the vapor pressure of the organic solvent introduced into the HDD (block 202) is an attribute to consider in regard to the manner in which the organic solvent is introduced into the HDD.

According to one embodiment, at optional block 206a a fabric is substantially saturated with the organic solvent and then the fabric is placed somewhere within the HDD. The fabric (e.g., a pouch) need not be physically saturated with the organic solvent, rather the fabric should at least have some organic solvent absorbed therein. According to another embodiment, at optional block 206b the organic solvent is incorporated with a recirculation filter constituent to the HDD and then the recirculation filter is placed somewhere within the HDD. Recirculation filters are commonly used in HDDs for the mitigation and/or capture of various types of contaminant particles within the HDDs. Whether using a simple fabric pouch, a recirculation filter, a reservoir, or another solvent introduction mechanism or component for introducing an organic solvent into an HDD, the placement and positioning of the mechanism may vary from implementation to implementation. The placement may depend generally on the system-level design and configuration of the HDD (e.g., whether or not the HDD includes a bypass channel) and associated spatial constraints within the HDD and more specifically, for example, on the airflow (or lighter-than-air gaseous flow) patterns and velocities within the HDD, the pressure differential(s) that may be achievable through the solvent introduction mechanism, the locality of the source(s) of the organic contaminants being mitigated, and the like.

### Extensions and Alternatives

In the foregoing description, embodiments of the invention have been described with reference to numerous specific details that may vary from implementation to implementation. Therefore, various modifications and changes may be made thereto without departing from the broader spirit and scope of the embodiments. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

In addition, in this description certain process steps may be set forth in a particular order, and alphabetic and alphanumeric labels may be used to identify certain steps. Unless specifically stated in the description, embodiments are not necessarily limited to any particular order of carrying out such steps. In particular, the labels are used merely for convenient identification of steps, and are not intended to specify or require a particular order of carrying out such steps.

1. A hard disk drive comprising:
a recording disk medium rotatably mounted on a spindle;
a read-write head slider comprising a read-write transducer configured to read from and to write to said disk medium;
a voice coil actuator configured to move said head slider to access portions of said disk medium; and
a solvent introduction mechanism comprising an organic solvent without a corresponding solute;
wherein said organic solvent acts to dissolve organic contaminants within said hard disk drive.

2. (canceled)

3. The hard disk drive of claim 1, wherein said organic solvent acts to dissolve at least a portion of hydrocarbons within said hard disk drive.

4. The hard disk drive of claim 1, wherein said organic solvent acts to dissolve at least a portion of siloxanes within said hard disk drive.

5. The hard disk drive of claim 1, wherein said organic solvent comprises toluene (C₇H₈).

6. The hard disk drive of claim 1, wherein said organic solvent comprises hexane (C₆H₁₄).

7. The hard disk drive of claim 1, wherein said solvent introduction mechanism comprises:
a fabric in which said organic solvent is absorbed.

8. The hard disk drive of claim 1, wherein said solvent introduction mechanism comprises:
a recirculation filter comprising said organic solvent.

9. A method for mitigating organic contaminants within a hard disk drive, the method comprising:
introducing an organic solvent, without a corresponding solute, into said hard disk drive to dissolve said organic contaminants.

10. The method of claim 9, wherein said organic solvent comprises toluene (C₇H₈).

11. The method of claim 9, wherein said organic solvent comprises hexane (C₆H₁₄).

12. The method of claim 9, wherein introducing said organic solvent acts to dissolve at least a portion of hydrocarbons within said hard disk drive.

13. The method of claim 9, wherein introducing said organic solvent acts to dissolve at least a portion of siloxanes within said hard disk drive.

14. The method of claim 9, wherein introducing said organic solvent includes substantially saturating a fabric with said organic solvent, and said method further comprising:
placing said fabric substantially saturated with said organic solvent into said hard disk drive.

15. The method of claim 9, wherein introducing said organic solvent includes incorporating said organic solvent with a recirculation filter, and said method further comprising:
placing said recirculation filter with said organic solvent into said hard disk drive.

16. The hard disk drive of claim 1, wherein said organic solvent acts to dissolve organic contaminants adsorbed on a surface of said disk medium.

17. The hard disk drive of claim 1, wherein said organic solvent acts to dissolve organic contaminants deposited on a surface of said head slider.

18. The hard disk drive of claim 1, wherein said organic solvent has a sufficient vapor pressure to diffuse inside said hard disk drive.

19. The method of claim 9, wherein introducing said organic solvent into said hard disk drive includes dissolving said organic contaminants adsorbed on a surface of a recording disk medium housed in said hard disk drive.

20. The method of claim 9, wherein introducing said organic solvent into said hard disk drive includes dissolving said organic contaminants deposited on a surface of a read-write head slider housed in said hard disk drive.

21. The method of claim 9, wherein said organic solvent has a sufficient vapor pressure to diffuse inside said hard disk drive.
